(19) United States
(12) Patent Application Publication
(10) Pub. No.: US 2006/0019083 A1
(43) Pub. Date: Jan. 26, 2006

(54) Moulded foam orticle provided with release suface

(76) Inventor: Silvio Giogetta, Schweiz (CH)

Correspondence Address: HOUSTON ELISEEVA, 4 MILITIA DRIVE, SUITE 4, LEXINGTON, MA, 02421, US

(21) Appl. No.: 10/536,418

(22) PCT Filed: Nov. 25, 2003
(86) PCT No.: PCT/EP03/13262

§ 371 Date: May 25, 2005

(30) Foreign Application Priority Data
Nov. 25, 2002 (EP) 102 54 922.2

(51) Int. Cl. B32B 3/26; B32B 3/12; B32B 3/00

(52) U.S. Cl. 428/304.4; 428/314.4; 428/159

(57) ABSTRACT

A moulded foam article made of closed cell or open cell foamed polymers, wherein at least one of the surfaces is provided completely or partially with a release coating of a cured, modified silicone compound. Such a molded body is preferably a foam web.

The present invention relates to a moulded foam article, in particular a foam web having a release (or dehesive) surface as typically known from sealing films and sealing papers in the adhesive tape industry.

Foam webs are used for a number of applications like sealing tapes and adhesive tapes, sealings, spacers, membranes, cushions, isolations, encapsulations etc., in which the foam is attached at the application site using a self-adhesive adhesive coating, such as sealing tapes in the household and isolation membranes in automobiles.

This self-adhesive coating is either applied with the full surface or a part of the surface, in the form of lines or dots, and is mostly, but not exclusively, applied one-sided and is protected until the time of attachment by a sealing film or a sealing paper.

In the above mentioned applications foam webs are preferred to other materials like films, papers, textiles, non-wovens etc. because of different reasons: foam webs are compressible, soft, flexible and adapt themselves to rough, contoured or otherwise irregular, uneven surfaces. Further, foam webs and parts and products prepared thereof are also sealing, shock-absorbing, thermally and acoustically isolating, gastight, watertight and self-supporting. They are further thermally mouldable and may be processed mechanically by processes such as deep drawing, embossing, splitting, grinding and perforating. The extent of the above-mentioned properties and the suitability for the above processing methods depends on the polymers used, the foaming degree, but also on further production and processing parameters.

Although the foam itself as well as the adhesive and the sealing film or the sealing paper fulfil their function in above-mentioned applications, there remains the basic problem that the sealing film or the sealing paper are a severe waste problem for the user. In order to solve this problem, today foam supports are provided permanently with a release (dehesive) film before further processing, which is e.g. laminated on the foam web using an adhesive. This procedure is involved with efforts as regards the process as well as in view of the costs of the purchased release film.

The applicant has performed experiments to coat foams directly and dehesively with silicones, which, however, were not successful due to the processes of thermal silicone crosslinking which unacceptably damaged the foam support due to the high temperature (silicones with a Pt- or Sn-catalyzed crosslinking system). As a further problem there is the risk that in case of incompletely cured silicone systems the adhesives are contaminated by migrating silicone components being uncrosslinked due insufficient crosslinking. Further, the problem was observed that components of the foam compositions migrate excessively to the surfaces and in particular into the release layer and through this layer due to the high temperature of the thermal crosslinking, and thus the properties thereof or the properties of the overlying adhesive are affected.

It is therefore an object of the present invention to provide moulded foam articles the surface of which is equipped dehesively in such a manner that self-adhesive moulded parts made thereof such as tapes, webs etc. can be stacked on themselves or be wound up without the foams or the adhesive layer being contaminated or thermally damaged.

The present invention thus relates to a moulded foam articles made of an open cell or closed cell foamed polymer, characterized in that at least one of the surfaces thereof is provided completely or partly with a release (dehesive) coating of a cured, modified silicone compound.

A foam according to the present invention allows to manufacture a product by further processing, in particular by coating with an adhesive, which can be applied by the user without a sealing paper and which simultaneously avoids the efforts of film laminating in the production of adhesive tapes or adhesive films. The provided dehesive or release property of the subject-matter of the present invention is based on compounds which are curable by electromagnetic radiation (UV or electron radiation) while avoiding high temperatures.

The form of the foams which can be provided with a release coating according to the present invention is not particularly limited, however, they are preferably foam webs or foam webs which have been shaped three-dimensionally by deep drawing or compression moulding, or which surfaces have been structured by an embossing process. Such webs may also be perforated by means of needles or with a laser.

Suitable polymers for the production of foams are particularly olefin homopolymers and olefin copolymers such as polyethylene (LDPE, MDPE, HDPE), copolymers of ethylene with other α-olefins having 3 to 6 carbon atoms, homopolymers and copolymers of propylene, such as polypropylene or ethylene-propylene copolymerisates. Further, other ethylene copolymers like LLDPE, VLLDPE, E/VA, E/BA, E/MA, E/EA, E/AS, E/VOH, polybutylene, thermoplastic elastomers or polyvinyl chloride, polyurethane, polystyrene, polyamides, polyesters, polyimides, polyketones, polysulfones or mixtures of such polymers are also suitable.

For the purposes of the present invention all foams known from the prior art are suitable. These foams may be crosslinked or not crosslinked. The used foam may be closed cell, partially open cell or open cell. Furthermore, the foam web may have a processing skin on one side or both sides.

The modified silicone compound used for the production of the release coating should be curable by electromagnetic radiation such as electron radiation or UV radiation. Suitable herefor are oligomeric silicones (polysiloxanes) which are modified by reactive organic groups capable of crosslinking, such as ethylenically unsaturated groups or epoxide groups. Examples for the unsaturated groups are vinyl groups, acrylate groups and methacrylate groups. Suitable modified silicones for the purposes of the present invention are e.g. described by R. Mehnert et al in UV & EB Curing Technology & Equipment, Volume I, Chapter I, pages 5 to 8 (John Wiley & Sons, 1998). Further examples for such silicone compounds are mentioned in EP 0 940 422, EP 0 867 460, EP 0 867 462, EP 0 835 897, EP 0 882 752, EP 0 887 367, EP 0 940 458, EP 0 999 230, EP 1 000 959, EP 1 029 878, EP 1 035 153, EP 1 142 929, EP 1 174 469, EP 1 072 660, EP 1 158 023, EP 1 227 133, EP 1 148 089 and EP 1 142 946.

In the production of the moulded foam article of the present invention having a release coating, first the surface of the foam material is chemically or physically treated in order to adjust the surface tension to the required value of 35 to 70 mN/m.

Subsequently; the coating mixture comprising the modified silicone compound, optionally a photoinitiator, as well as optionally a primer and optionally solvents, is applied in a common coating device, e.g. by means of doctor blades or rolls.

Preferably a solvent-free coating mixture is used.

The coated material or the coated web is then irradiated in an inert atmosphere by UV radiation or electron radiation in order to cure the coating.

In the enclosed figures FIG. 1 shows a foam web (1) which has been coated directly and dehesively (2) according to the present invention.

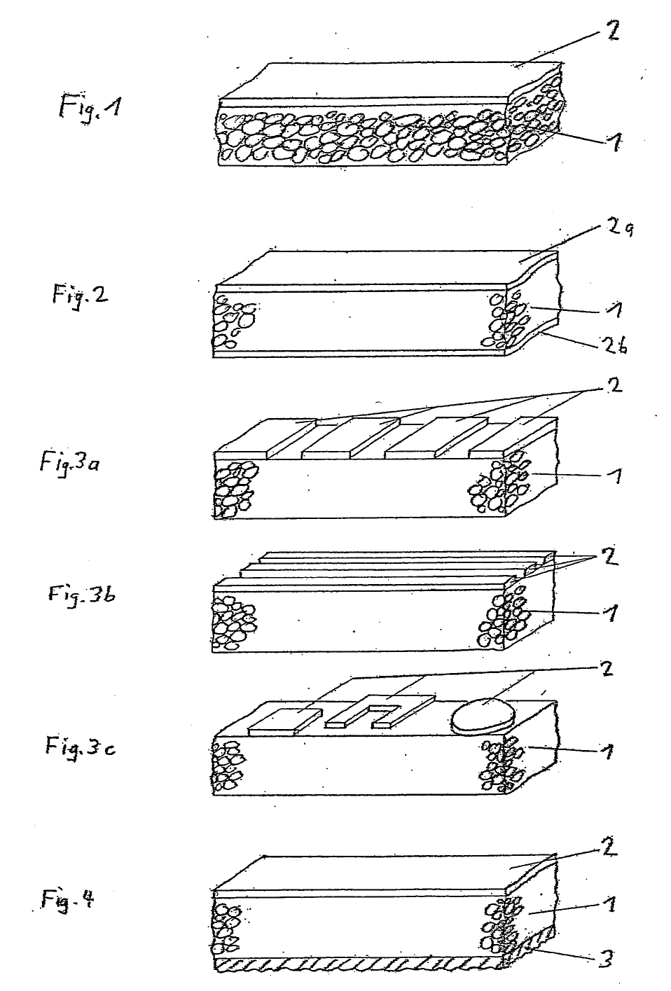

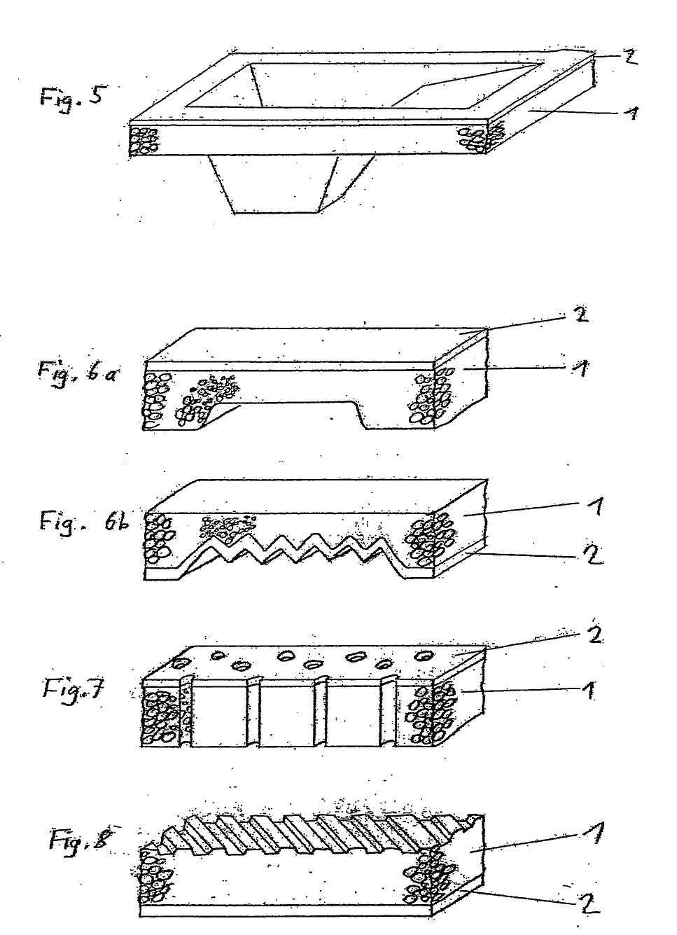

In FIGS. 2, 3a, 3b, 3c and 4 embodiments are shown, namely a foam web (1) provided with release coatings (2a, 2b) on both sides in FIG. 2, or variants which are provided on parts of the surface with transversally (FIG. 3a), longitudinally (FIG. 3b) or randomly (FIG. 3c) arranged release coatings, as well as an embodiment (FIG. 4) in which the surface opposite to the release coating (2) is provided with another functional layout (3). A further embodiment of a deep drawn foam section is shown in FIG. 5, and two hot-press moulded variants are shown in FIG. 6a, wherein the side opposite to the release coating was compressed, and in FIG. 6b, where the side of the release coating was compressed. Finally, in FIG. 7 an embodiment perforated by a needle or laser process is shown, and in FIG. 8 an embodiment having an embossed, in this example corrugated, surface is shown.

The present invention is further described below by means of illustrative embodiments.

The subject-matter of the invention according to FIG. 1 is in a first embodiment prepared from a polyolefine foam web (1) as e.g. in patent CH 505681 (physically crosslinked polyolefine foam) and EP 0159384 (physically crosslinked polypropylene foam) or in EP 0329490 (chemically-physically crosslinked polyolefine foam). Further embodiments are based on other polymers as in EP 0053190 A1 (PVC-foam) or in U.S. Pat. No. 4,216,177 (PUR-foam). This first embodiment according to FIG. 1 is treated on one side physically or chemically, e.g. with a corona discharge or with fluorine gas (according to EP 0214635), in order to increase the surface tension to the required degree of 35-70 mN/m according to the respective application. Then, the coating mixture, e.g. a silicone acrylate system, to which a photoinitiator is admixed for the subsequent UV-crosslinking, is applied with a multi-roll application device on the pretreated side, and the coated web is passed in an inert atmosphere under a UV irradiator in order to cure the coating and to thus obtain a foam web (1) having a silicone release coating (2). Two examples for a very easily detachable release coating and a release coating which is detachable in a controlled manner at a higher force value, are described in the following table.

TABLE

| | silicone | silicone | silicone | photo | adhesive | | Finat Test | Finat Test | Finat Test |
|---|---|---|---|---|---|---|---|---|---|
| component | acrylate | acrylate | acrylate | initiator | agent | | FTM 10*) | FTM 10*) | FTM 10*) |
| chemical | silicone | silicone | silicone | 2-Hydroxy-2- | trifunctional | | | | |
| formula | acrylate | acrylate | acrylate | methyl-1- | acid ester ¹⁾ | | | | |
| | with low | with medium | with high | phenyl-1- | CAS No. | | | | |
| | acrylate | acrylate | acrylate | propanone | 28961-43-5 | | | | |
| | content | content | content | CAS No. | (s.MSDS) | | | | |
| | (appr. 2.5%) | (appr. 10%) | (appr. 20%) | 7473-98-5 | | | | | |
| product and | Gold- | Gold- | Gold- | Chiba | Sartomer | | Tesa 7476 | Tesa 7475 | |
| supplier | schmidt | schmidt | schmidt | Darocur | SR 9051 | | | | |
| | AG Tego | AG Tego | AG Tego | 1173 | | | | | |
| | RC 902 | RC 715 | RC 711 | | | | | | |
| | | | | | | FG | AK | AK | |
| | % | % | % | | % | g/m² | N/m | N/m | RKK % |
| formulation | 70 | | 30 | 2 | 5 | 1.3 | 17 | 2.8 | 85 |
| 1: very | | | | | | | | | |
| dehesive | | | | | | | | | |
| formulation | | 70 | 30 | 2 | 5 | 1.1 | 35 | 5.5 | 8.7 |
| 2: controlled | | | | | | | | | |
| dehesive | | | | | | | | | |

FG: area weight
AK: detachment force after one day storage at 40° C.
RKK: remaining adhesive force
¹⁾ mixture of methacrylic acid ester and ethoxylated trimethylolpropane-triacrylate ester
*)described in FINAT technical handbook, 6th edition 2001

1. Moulded foam article made of a closed cell or open cell foamed polymer, which is completely or partially provided with a release coating of a cured, modified silicone compound on least one of the surfaces thereof, obtainable by applying a solvent-free modified silicone compound, which is an oligomeric silicone being modified by crosslinkable olefinically unsaturated groups and/or by epoxide groups, on the polymer, and curing the coating by means of electro-magnetic radiation.

2. Moulded foam article according to claim 1, wherein the foam is a polyolefine foam, preferably a crosslinked polyolefine foam.

3. Moulded foam article according to claim 1, wherein the foam is a polyurethane foam.

4. Moulded foam article according to claim 1, wherein the foam is a polyvinyl chloride foam.

5. Moulded foam article according to anyone of claims 1 to 4, wherein the modified silicone compound is modified with (meth)acrylate groups.

6. Moulded foam article according to anyone of claims 1 to 5, wherein the release coating is applied in an amount in the range of 0.1 to 10 g/m², preferably from 0.4 to 2 g/m².

7. Moulded foam article according to anyone of claims 1 to 6, wherein the coating contains a curing initiator and is cured by irradiation with UV radiation.

8. Moulded foam article according to anyone of claims 1 to 6, wherein the coating is cured by electron radiation.

9. Moulded foam article according to anyone of claims 1 to 8, which is a foam web.
